(19) United States
(12) Patent Application Publication
(10) Pub. No.: US 2006/0007136 A1
(43) Pub. Date: Jan. 12, 2006

(54) Operation input device and terminal device which uses the operation input device

(76) Inventor: Shin Nakagome, Tokyo (JP)

Correspondence Address: KATTEN MUCHIN ROSENMAN LLP, 575 MADISON AVENUE, NEW YORK, NY, 10022-2585, US

(21) Appl. No.: 11/176,583

(22) Filed: Jul. 6, 2005

(30) Foreign Application Priority Data
Jul. 7, 2004 (JP) 2004-200254

(51) Int. Cl. G09G 5/00

(52) U.S. Cl. 345/156

(57) ABSTRACT

The present invention provides an operation input device which can intuitively perform an operation to turn over papers, an operation to snap an object and the like, and a terminal device which uses the operation input device. As a specific examples the terminal device includes an elastic body that is resilient, and the operation input device which detects an amount of deflection of the elastic body attributed to the operation of a user and outputs information relating to the detected amount of deflection.

### BACKGROUND OF THE INVENTION

The present invention relates to an operation input device which detects an operation of a user, and a terminal device which uses the operation input device.

Recently, as a device for inputting an instruction operation of a user, various operation input devices including a so-called jog dial and the like have been developed, as well a keyboard, a mouse etc. For example, the jog dial can realize intuitive operation of a scroll display by a dial operation.

Various examples of input devices are disclosed in “computer architecture (second revised version)” second revised version, Ohm Ltd., written by Takanobu Baba, published on Feb. 25, Heisei12 (2000), from page 228 to page 230.

However, despite the fact that the number of computer applications for handling a stack of paper, such as data on documents and books, has increased, there is still no interface which provides an intuitive operation corresponding to turning over the stack of paper. Accordingly, in most currently available equipment, an operation to turn over a stack of paper is realized by an operation that is similar to scrolling. There is also no interface which can intuitively perform an operation such as flipping, by which is meant an operation of a finger similar to the turning-over of the stack of papers.

The present invention has been conceived under such circumstances and it is one of objects of the present invention to provide an operation input device which can realize an intuitive instructive operation such as turning over papers or flipping an object, and a terminal device which uses such a operation input device.

### SUMMARY OF THE INVENTION

To overcome the above-mentioned drawbacks of the related art, according to a first aspect of the present invention, there is provided a operation input device including an elastic body which possesses resiliency, a device which detects an amount of deflection of the elastic body attributed to an operation of a user, and a device which outputs information relating to the detected amount of deflection.

Further, according to another aspect of the present invention, there in provided a terminal device which uses such an operation input device.

### BRIEF DESCRIPTION OF THE DRAWINGS

FIG. 1 is a plan view showing one example of a terminal device according to an embodiment of the present invention;

FIG. 2 is a constitutional block diagram showing an example of the terminal device according to the embodiment of the present invention;

FIG. 3A is a perspective view showing an example of an operation input device according to the embodiment of the present invention;

FIG. 3B is a side view showing an example of an operation input device according to the embodiment of the present invention;

FIG. 3C is a side view showing another example of an operation input device according to the embodiment of the present invention;

FIG. 4 is a flow chart showing an operational example of the terminal device according to the embodiment of the present invention;

FIG. 5 is a perspective view showing another example of the operation input device according to the embodiment of the present invention;

FIG. 6 is an explanatory view showing an example of a shape of a cover of the operation input device;

FIG. 7A is an explanatory view showing an example of variation over time of an amount of deflection when a user deflects an elastic body in the operation input device according to the embodiment of the present invention with a relatively weak force and, thereafter, the user quickly removes his/her finger from the elastic body;

FIG. 7B is an explanatory view showing an example of variation over time in amount of deflection when a user deflects an elastic body in the operation input device according to the embodiment of the present invention by gradually applying a force to the elastic body and, thereafter, the user quickly removes his/her finger from the elastic body at a point in time when the user applies a relatively strong force; and

FIG. 7C is an explanatory view showing an example of variation over time in amount of deflection when a user deflects an elastic body in the operation input device according to the embodiment of the present invention with a relatively strong force and thereafter, the user gradually reduces the force and, finally, the user gently removes his/her finger from the elastic body.

### DESCRIPTION OF THE PREFERRED EMBODIMENTS

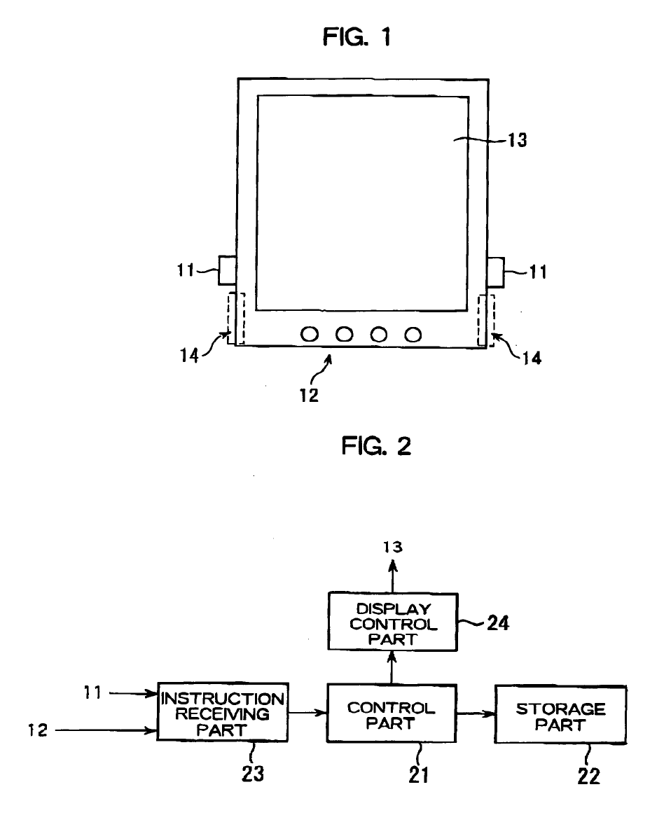

Hereinafter, embodiments of the present invention are explained in conjunction with the attached drawings. A terminal device according to the embodiment of the present invention includes, as shown in FIG. 1, operation input devices 11, an operation part 12, and a display part 13. The operation part 12 is constituted of an inputting device such as button switches or the like, while the display part 13 is constituted of a display device such as a liquid crystal display. The operation input devices 11 will be explained later. FIG. 1 is a plan view showing one example of the terminal device according to the present invention.

The display part 13 and the operation part 12 are mounted on an upper surface side of a casing having a substantially thin box shape, while the operation input devices 11 are respectively mounted on both side surfaces of the casing. Here, a portion of the operation part 12 may be mounted on a side surface and/or a back surface of the casing. Further, grip portions 14 (indicated by a broken line in FIG. 1) are respectively formed on sides of the respective operation input devices 11. A user usually performs the operation by grasping the terminal device with both of his/her hands using these grip portions 14.

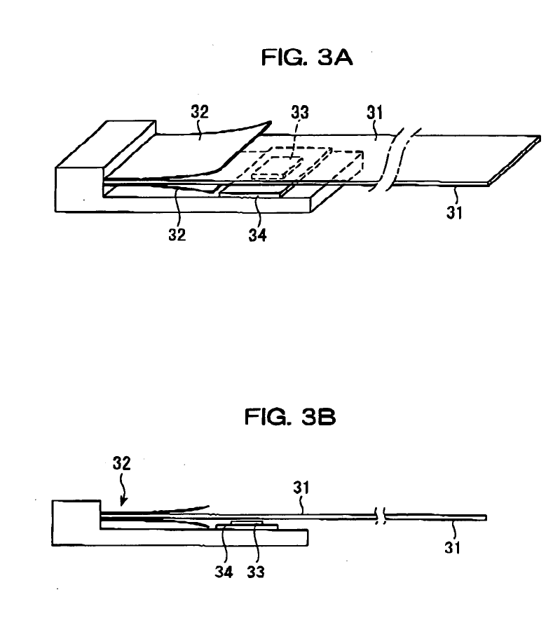

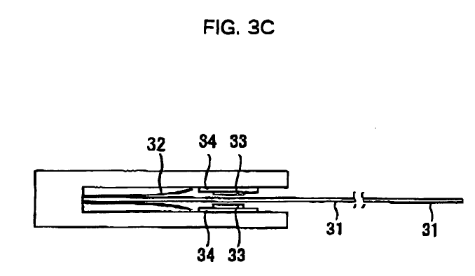

Further, the terminal device is, as shown in FIG. 2, constituted of a control part 21, a storage part 22, an instruction receiving part 23, and a display control part 24. The operation input device 11 is, as shown in FIG. 3A, FIG. 3B and FIG. 3C, constituted of a plate-like body 31 which forms an elastic body having resiliency, a support portion 32 which supports the plate-like body 31, a detecting portion 33 which detects an amount of deflection of the plate-like body 31 attributed to the operation of a user, and an information outputting portion 34 which outputs information relevant to the amount of deflection of the plate-like body 31 detected by the detecting portion 33. FIG. 3A is a perspective view of one example of the operation input device 11, while FIG. 3B is a side view of one example of the operation input device 11 and FIG. 3C is a side view Showing another example of an operation input device according to the embodiment of the present invention. Here, to facilitate understanding of FIG. 3A, FIG. 3B and FIG. 3C, an example which is provided with the detecting portion 33 on only one surface side of the terminal device is illustrated.

The control part 21 is operated in accordance with a program which can be realized by a CPU or the like and is stored in the storage part 22. An example of the content of the specific processing executed by the control part 21 is explained in detail later. The storage part 22 is realized by the driving of a storage element such as a RAM (Random Access Memory) or a computer readable recording medium such as a hard disc or a DVD. The storage part 22 stores the program executed by the control part 21. Further, the storage part 22 also functions as a work memory of the control part 21 and holds various data which become necessary for the processing executed by the control part 21.

The instruction receiving part 23 is connected to the operation part 12 and the operation input devices 11, When the button switch which constitutes the operation part 12 is pressed, the instruction receiving part 23 outputs a signal indicative of the pressing of the button switch to the control part 21. Further, the instruction receiving part 23, upon receiving the inputting of information relevant to the amount of deflection of the plate-like body 31 which is included in the operation input device 11 from the operation input device 11, outputs the information to the control part 21. The display control part 24 is connected to the display part 13 and displays an image on a display which constitutes the display part 13 in accordance with the instruction inputted from the control part 21.

A portion of the plate-like body 31 of the operation input device 11 projects outside the casing. The plate-like body 31 is made of a resilient material. As such a material, for example, various resins such as acrylic resin, vinyl chloride resin, polypropylene, polycarbonate, PET resin, vinylidene chloride resin, fluororesin, melamine resin, phenol resin, unsaturated polyester resin, urethane resin rubber and metals such as iron or copper are used. Further, even when a material has rigidity, by adopting a method which forms the material in a helical shape, it is possible to impart resilience to the material. A planar shape of the plate-like body 31 may have any shape including a rectangular shape shown in FIG. 3A, for example.

The support portion 32 is fixed to the inside of the casing of the terminal device and supports a portion of the plate-like body 31. To be more specific, the support portion 32 includes two leaf springs which have distal end portions thereof curved outwardly and these leaf springs support the plate-like body 31 by clamping the plate-like body 31. When the plate-like body 31 is deflected by a user, the plate-like body 31 is deflected using the support portion 32 as a fulcrum.

The detecting portion 33 is a pressure sensor (a piezoelectric sensor or the like) and, for example, as shown in FIG. 3A and FIG. 3B, the detecting portion 33 is provided in the vicinity of the support portion 32, that is, on a side where the plate-like body 31 is clamped by the support portion 32. With such a constitution, when the plate-like body 31 is deflected, with a pressure which corresponds to the amount of deflection of the plate-like body 31, the piezoelectric sensor formed on a surface of the plate-like body 31 on a side in the deflecting direction is pressed. Accordingly, the pressure sensor which constitutes the detecting portion 33 outputs a voltage signal relating to a pressure generated by the pressing as information relating to the amount of deflection of the plate-like body 31. Here, in this embodiment, as shown in FIG. 3C, the piezoelectric sensor is mounted on both surface sides of the plate-like body 31 and hence, the piezoelectric sensor can detect the pressure which is generated when the plate-like body 31 is deflected in the direction toward a bottom surface of the casing, as well as the pressure which is generated when the plate-like body 31 is deflected in the direction toward a top surface of the casing.

The information outputting portion 34 outputs the information relating to the amount of deflection of the plate-like body 31 which is detected by the detecting portion 33. To be more specific, when the signal which the detecting portion 33 outputs is a voltage signal, the information outputting portion 34 converts the voltage signal into a digital value and outputs the digital value after conversion.

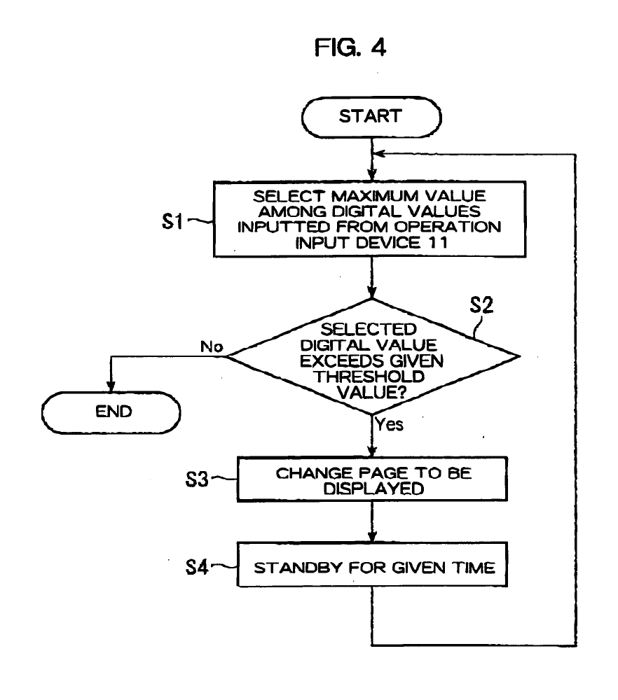

Here, a specific example of the processing executed by the control part 21 is explained. To be more specific, here, the explanation is given with respect to a case in which the processing which displays a document consisting of a plurality of pages, such as a book reference program, a telephone directory reference program or the like, is performed. The control part 21, as shown in FIG. 4, selects the maximum value from digital values which are inputted from the operation input device 11 (S1) Here, since the detecting portions 33 are respectively mounted in the deflecting directions (both upper and lower directions) of the plate-like body 31 of the operation input device 11, there exist two digital values inputted from one operation input device 11, while the operation input devices 11 are respectively mounted on the left and right sides of the casing. Accordingly, four digital values in total are inputted to the control part 21.

Further, these digital values are changed as follows, for example. That is, in a state where the plate-like body 31 of the operation input device 11 is not deflected (a natural state), neither one of the detecting portion 33 formed on the upper side of the detecting portion 33 and the detecting portion formed on the lower side of the detecting portion 33 receive the pressure and hence, the digital values which are obtained from these detecting portions 33 indicate that no pressure is received (for example, “0”).

On the other hand, when the user bends the plate-like body 31 in the direction toward the lower side (the direction toward a surface opposite to the display part 13 of the casing), the detecting portion 33 formed on the lower side of the plate-like body 31 receives the pressure. Accordingly, the digital value which is obtained from the detecting portion 33 formed on the lower side of the plate-like body 31 is changed to a value corresponding to the pressure (for example, the positive value). This digital value is changed in response to the bending quantity (that is, the amount of deflection of the plate-like body 31). For example, the digital value is changed such that as the deflection becomes larger, the digital value is increased. Here, since the detecting portion 33 formed on the upper side of the plate-like body 31 does not receive the pressure, the digital value which is obtained from the detecting portion 33 indicates that no pressure is received (for example, “0”).

In the same manner, when the user bends the plate-like body 31 in the direction toward the upper side (in the direction toward the surface of the display part 13 of the casing), the detecting portion 33 formed on the upper side of the plate-like body 31 receives the pressure, while the detecting portion 33 formed on the lower side of the plate-like body 31 does not receive the pressure. That is, the digital value which is obtained from the detecting portion 33 provided to the upper side of the plate-like body 31 is changed to a value (for example, the positive value) corresponding to the pressure, while the digital value obtained from the lower-side detecting portion 33 is held at a value (for example “0”) which indicates that the lower-side detecting portion 33 does not receive the pressure.

Accordingly, in this embodiment, also by taking into consideration a case in which the user erroneously touches the plate-like body 31, whether the manipulation is performed or not is determined based on the magnitude of the pressure. That is, when the amount of deflection of the plate-like body 31 is smaller than a given quantity, the processing corresponding to the amount of deflection is not performed. That is, the control part 21 determines whether the digital value selected in the processing S1 exceeds a given threshold value or not (52) and finishes the processing as it is when the digital value does not exceed the given threshold value.

When the digital value selected in the processing S1 exceeds the given threshold value in the processing S2, the control part 21 performs the processing to change the page to be displayed depending on which detecting portion 33 the selected digital value corresponds (S3). To be more specific, the control part 21 determines which one of following cases the digital value selected in the processing S1 satisfies.
(1) a case in which the detecting portion 33 is provided to the lower side of the plate-like body 31 of the operation input device 11 on the left side of the casing (hereinafter referred to as “left lower operation”)
(2) a case in which the detecting portion 33 is provided to the upper side of the plate-like body 31 of the operation input device 11 on the left side of the casing (hereinafter referred to as “left upper operation”)
(3) a case in which the detecting portion 33 is provided to the lower side of the plate-like body 31 of the operation input device 11 on the right side of the casing (hereinafter referred to as “right lower operation”)
(4) a case in which the detecting portion 33 is provided to the upper side of the plate-like body 31 of the operation input device 11 on the right side of the casing (hereinafter referred to as “right upper operation”)

Then, when the digital value selected in the processing S1 satisfies either the left lower operation or the right upper operation, the page to be displayed is incremented by 1 page, for example. Further, when the digital value selected in the processing S1 satisfies either the left upper operation or the right lower operation, the page to be displayed is decremented by 1 page, for example. Then, the control part 21 stands by for a predetermined time (S4) and returns to the processing S1 to continue the processing.

Here, the control part 21 in the processing S3 may change the content of the page changing control depending on whether the displayed document is written vertically (Japanese-written novels or the like) or horizontally. That is, in the case where the document is written horizontally, as described above, when the digital value selected in the processing S1 satisfies either the left lower operation or the right upper operation, the page to be displayed is incremented, while the digital value selected in the processing S1 satisfies the left upper operation or the right lower operation, the page to be displayed is decremented Further, in the case where the document is written vertically, in other words when the pages are turned from right to left, contrary to the above processing, when the digital data selected in the processing S1 satisfies either the left lower operation or the right upper operation, the page to be displayed is decremented, while when the digital data selected in the processing S1 satisfies the left upper operation or the right lower operation, the page to be displayed is incremented.

Still further, the control part 21 may change the page turning speed corresponding to the magnitude or the digital value selected in the processing S1, that is, the amount of deflection of the plate-like body 31. To be more specific, as the amount of deflection becomes larger, the page turning speed is increased. To change the page turning speed, the standby time in the step S4 is made variable and the control part 21 performs the adjustment such that as the amount of deflection becomes larger, the standby time in the processing S4 is shortened.

According to the terminal device of this embodiment, the user can, at the time of turning over the pages of the document, instruct the operation by performing the manipulation to deflect the plate-like body 31 so that the user can realize an intuitive operation in the same manner as the turning over of a stack of papers.

Further, in the operation input device 11 of this embodiment, the distal end portions of two leaf springs which are included in the support portion 32 are curved outwardly thus facilitating an operation to pull out the plate-like body 31 from these two leaf springs and an operation to insert the plate-like body 31 between these two leaf springs. Due to such a constitution, it is possible to replaceably use plate-like bodies 31 which differ in a resilient force depending on the content of the processing of the control part 21, or the plate-like body 31 can be exchanged when the plate-like body 31 is deteriorated. Further, plate-like bodies 31 which differ in color, pattern, quality or the like may be provided so that user can freely select the plate-like body 31 according to with their personality.

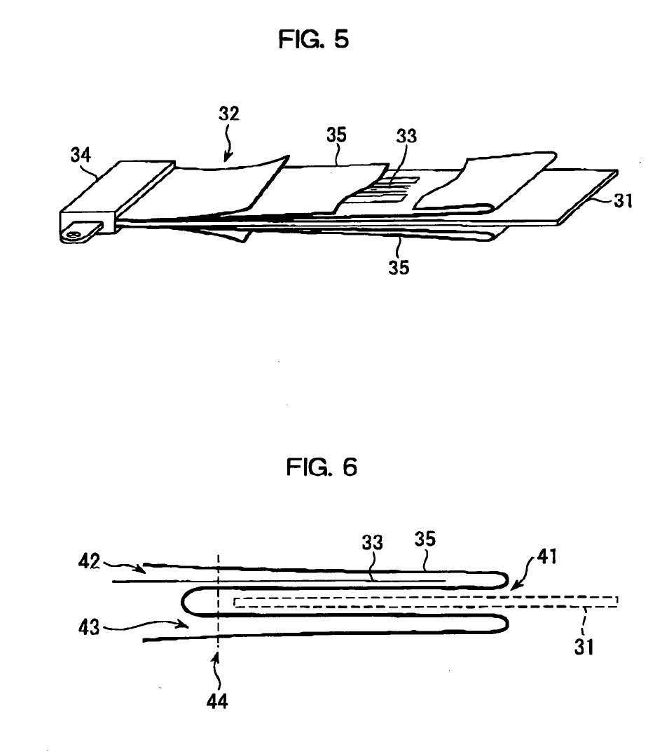

Further, although the explanation has been given with respect to the case in which the operation input device 11 detects the amount of deflection of the plate-like body 31 using the pressure sensor, a strain gauge may be used for detecting the amount of deflection in place of the pressure sensor. The operation input device 11 which uses the strain gauge includes, as shown in FIG. 5, a resilient plate-like body 31, a support portion 32, a detecting portion 33 which contains a strain gauge, an information outputting portion 34, and a cover 35. FIG. 5 illustrates a state in which part of the cover 35 is broken away to facilitate understanding of FIG. 5.

The cover 35 can be realized by using a material having higher resiliency than the plate-like body 31 and is folded in a M shape as shown in FIG. 6. Here, the cover 35 can receive the plate-like body 31 in a valley portion 41 formed at the center of the M shape, and the strain gauge 33 is fixed to the inside of at least one of upper and lower valley portions 42, 43. The cover 35 is fixed to a pedestal at a position indicated by a broken line on a left side in FIG. 6, that is, at a position of an end portion of the center valley portion 41 which receives the plate-like body 31. Further, the support portion 32 holds a portion of the plate-like body 31 in a state where the plate-like body 31 is wrapped with the cover 35.

In the operation input device 11 using the strain gauge, when the plate-like body 31 is deflected, the strain gauge which constitutes the detecting portion 33 which is fixed to the cover 35 is also deflected together with the plate-like body 31 and hence, an amount of deflection of the plate-like body 31 can be detected. Further, also in this example, it is possible to exchange the plate-like body 31 by pulling out the plate-like body 31 from the inside of the cover 35 or inserting the plate-like body 31 into the inside of the cover 35

Here, when it is unnecessary to exchange the plate-like body 31, it is possible to detect the amount of deflection of the plate-like body 31 by directly fixing the strain gauge which constitutes the detecting portion 33 to the plate-like body 31 In this manner, the cover 35 is not always necessary.

Further, although explanation has been given with respect to the case in which the control part 21 directly uses the digital value inputted from the operation input device 11 for processing heretofore, the control part 21 may perform the processing based on the time-based change of the digital value.

That is, the control part 21 records the digital values inputted from the operation input device 11 in the storage part 12 at a fixed interval. Then, based on the change of the plurality of recorded digital values, variation over time in the amount of deflection of the plate-like body 31 is detected. Accordingly, it is possible to provide the time-based change of the amount of deflection to given processing.

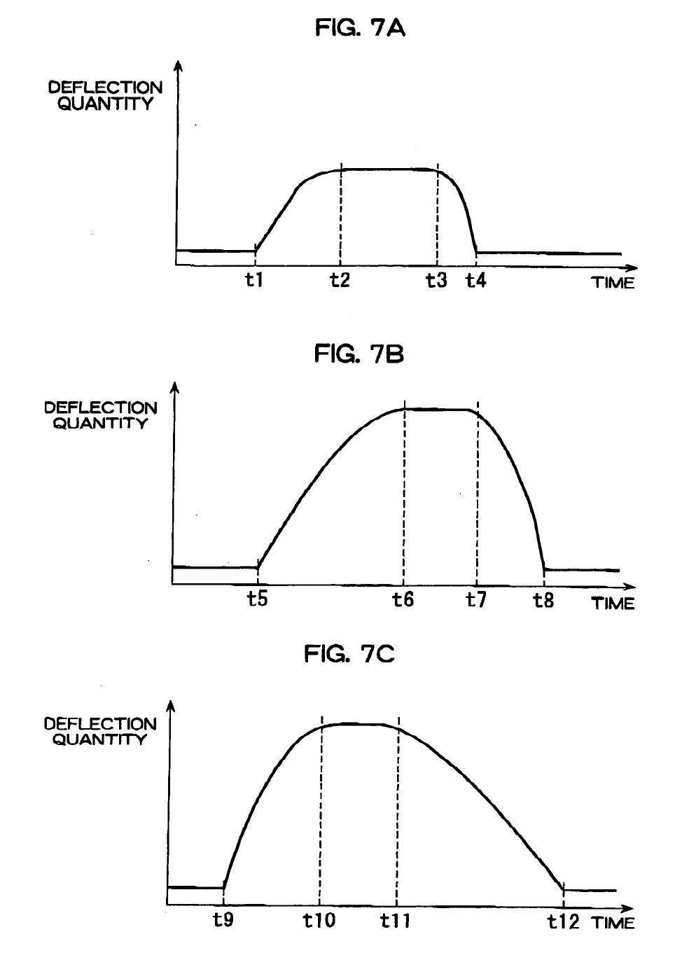

To be more specific, the digital values which the control part 21 records in the storage part 12 are changed as illustrated in FIG. 7A, FIG. 7B and FIG. 7C. FIG. 7A shows an example of variation over time in the amount of deflection of the plate-like body 31 when a user deflects the plate-like body 31 with a relatively weak force and, thereafter, the user quickly removes his/her finger from the plate-like body 31. FIG. 7B shows an example of variation over time in the amount of deflection of the plate-like body 31 when the user deflects the plate-like body 31 by gradually applying a force to the plate-like body 31 and, thereafter, the user quickly removes his/her finger from the plate-like body 31 at a point in time when the user applies a relatively strong force to the plate-like body 31. Further, FIG. 7C shows an example of variation over time in the amount of deflection when the user deflects the plate-like body 31 with a relatively strong force and, thereafter, the user gradually reduces the force and, finally, the user gently removes his/her finger from the plate-like body 31.

The control part 21 detects the deflecting speed or the restoring speed by calculating the differential (difference) of these changes. As a specific example, when the control part 21 writes the digital value which is stored i-th in a work memory of the storage part 12 as D(i), the control part 21 can detect the deflecting speed or the restoring speed in the following manner. That is, the control part 21 calculates a differential value D(i)-D(i−1) and performs the processing based on the differential value. Further, by considering the fact that there is a difference in the differential value also depending on the magnitude of the digital value when the digital value assumes the maximum value (the peak value), the differential value may be corrected by reference to the immediate peak value. That is, between the case in which the peak value is low and the case in which the peak value is large, the change speed of the amount of deflection of the plate-like body 31 when the plate-like body 31 is snapped in such states differs. That is, when the peak value is low, the change speed of the amount of deflection becomes relatively small. Here, the peak value is, with respect to the predetermined integer N, set to the largest value among D(i−n) which are stored in the storage part 12 (here, n being an integer which changes from 0 to N). Using such calculation, it is possible to obtain the immediate peak value.

Accordingly, the control part 21 may, for example, perform given processing using a value (a corrected value) which is obtained by dividing the differential value D(i)-D(i−1) With an increase function value f (P) which is increased along with the increase of the peak value P which is immediately recorded. Here, the increase function value f(P) may be P per se, for example, or the natural logarithm log(P).

The control part 21 performs the following operation, for example, using such a corrected value. That is, the control part 21 executes a gaming program for pinball, pachinko or the like and realizes the manipulation to snap a ball using the plate-like body 31. For example, when the corrected value is equal to or more than the given threshold value, an initial speed of the ball is set assuming that the ball is snapped with a force corresponding to the immediately-previous peak value. Further, when the corrected value is less than the given threshold value, an image of a bar which snaps the ball is moved in response to values at respective points in time. That is, even when the plate-like body 31 is deflected, it is possible to cancel the ball snapping operation by slowly restoring the deflection.

Further, it may be possible for the control part 21 to determine which one of following operations (a), (b) the user performs in response to whether the differential and the corrected value become equal to or more than the threshold values, and outputs the information indicative of the result of determination.

(a) an operation to snap the plate-like body 31

(b) an operation to slowly restore the plate-like body 31

Further, although whether the corrected value is equal to or more than the threshold value or not is checked here, in place of such processing, it may be possible for the threshold value to be corrected based on the immediately-previously-recorded peak value and the differential value and the corrected value are compared to determine whether the differential value becomes equal to or more than the corrected peak value.

The control part 21 may preliminarily perform the following processing as an operation to initialize the detection of amount of deflection of the operation input device 11. That is, the control part 21 displays “Place your finger. Don't press.” on the display part 13 and sets the digital value relating to the amount of deflection after a lapse of a fixed time to the minimum value in a state where the control part 21 receives no inputting (value “0” in the explanation made heretofore). Next, the control part 21 displays “Bend the plate as much as possible.” on the display part 13 and, thereafter, the control part 21 detects the digital value relating to the amount of deflection which is inputted within the fixed time, obtains the peak value, and sets the peak value as the maximum value relevant to the amount of deflection. Further, the control part 21 displays “Release the finger quickly.” on the display part 13 and, thereafter, the control part 21 calculates the difference of the digital value relating to the amount of deflection which Is inputted within a fixed time, and measures a speed when the plate-like body 31 restores with only the resiliency thereof. Then, the control part 21 sets a threshold value which becomes the reference in determining which one of the operation to snap the plate-like body 31 and the operation to slowly restore the plate-like body 31 is performed based on the above-mentioned differential value and the corrected value.

Further, the terminal device of this embodiment may be also provided, in the inside of the casing, with an accommodating device which includes a guide passage which allows the slide movement of the support portion 32 of the operation input device 11, and a locking device which engageably stops the support portion 32 at a position where the plate-like body 31 is pulled out along the guide passage and a position where the plate-like body 31 is accommodated. With the provision of the accommodating device, it is possible to accommodate the plate-like body 31 in the inside of the casing. The accommodating device may be a locking mechanism similar to a well-known push-type toggle switch. By adopting Such a mechanism, it is possible to accommodate the whole operation input device 11 including the plate-like body 31 in the inside of the casing by pushing the plate-like body 31 into the casing. When the plate-like body 31 is further pushed, the plate-like body 31 is projected outwardly from the casing. Further, a member which restricts the amount of deflection in the deflecting direction may be provided at an opening portion of the casing for projecting the plate-like body 31 as a means to restrict the amount of deflection of the plate-like body 31 With the provision of this member, even if the user tries to largely deflect the plate-like body 31, the amount of deflection Is restricted by the member and hence, the possibility of the plate-like body 31 rupturing can be decreased.

Further, although the explanation has been given with respect to the case in which the elastic body has a plate-like shape heretofore, the elastic body is not limited to such a case and the elastic body may have a rectangular parallelepiped shape, a columnar shape or other shape which is formed using a resilient material such as resin, rubber or metal.

Further, in the processing S3 of the control part 21 shown in FIG. 4, regardless of the digital values which are selected in the processing S1, the given processing may be performed by reference to the magnitudes of digital values inputted from all operation input devices 11. For example, with respect to the operation input device 11 which is arranged at the left and right sides, it may be possible to adopt processing in which when both plate-like bodies 31 are deflected downwardly, the screen is zoomed out and hence, the image data which is being displayed is shrunk In the same manner, it may be possible to adopt processing in which when both plate-like bodies 31 are deflected upwardly, the screen is zoomed in and the image data which is being displayed is enlarged.

Further, when the control part 21 detects the picking-and-pulling or the picking-and-pushing of the plate-like body 31 (the differential value or the corrected value being less than the threshold value, different from the snapping), the menu may be displayed instead of performing the page turning operation.

Further, with the use of the operation input device 11 of this embodiment, the control part 21 can realize, as the control of game characters, control of a swinging operation of a club or a bat in a golf game or a baseball game, control of a ball snapping operation in pinball or pachinko, and control of acceleration or the braking operation in a racing game. Further, as has been described heretofore in conjunction with the embodiment, by providing two operation input devices 11 on both sides of the casing of the terminal, it is possible to perform a balance game or a matching diagnosis game or the like. In such a game, in performing the game processing based on the difference in the amount of deflection between the left and right plate-like bodies 31, when the difference becomes excessively large, “failure” is displayed, and when the difference is within a range of fixed difference, “success” is displayed

Further, in this embodiment, when the terminal device includes a member which is resilient (for example, when the operation part 12 includes a touch panel or the like), the elastic body of the operation input device 11 may be formed of a member which is resilient in place of the plate-like body 31. With such a constitution, the control part 21 can also perform the given processing with an operation to bend the touch panel.

Further, although the explanation has been given with respect to the case in which the operation input device 11 is mounted inside the casing of the terminal device in this embodiment, the operation input device 11 may be constituted of an external device. In this case, the operation input device 11 outputs the information on the amount of deflection of the elastic body to the terminal device by way of an interface such as a USB.

While the present invention is described in terms of the preferred embodiments or exemplary embodiments, it is not limited hereto.

What is claimed is:

1. An operation input device comprising;
an elastic body which is resilient;
a device which detects an amount of deflection of the elastic body attributed to an operation of a user; and
a device which outputs information relating to the detected amount of deflection.

2. An operation input device comprising:
an elastic body which is resilient;
a support portion which supports a portion of the elastic body and constitutes a fulcrum when the elastic body is deflected;
at least one pressure sensor portion which is mounted on at least one surface side of the elastic body and in the vicinity of the support portion, and detects an amount of deflection of the elastic body; and
an information outputting portion which outputs information releating to the amount of deflection of the elastic body detected by the pressure sensor portion.

3. An operation input device according to claim 2, wherein the pressure sensor portion is arranged on both surfaces of the elastic body respectively.

4. An operation input device comprising:
an elastic body which is resilient;
a support portion which supports a portion of the elastic body and constitutes a fulcrum when the elastic body Is deflected:
at least one strain gauge portion which is mounted to be deflected integrally with the elastic body and detects an amount of deflection of the elastic body; and
an information outputting portion which outputs information relating to the amount of deflection of the elastic body detected by the strain gauge portion.

5. A terminal device comprising:
(a) an operation input part which includes an elastic body that is resilient, a device which detects an amount of deflection of the elastic body in accordance with an operation of a user, and a device which outputs information relating to the detected amount of deflection;
(b) a recording part which records information relevant to the amount of deflection of the elastic body of the operation input part plural times; and
(c) a control part which detects variation over time in the amount of deflection of the elastic body based on plural information recorded in the recording part, and performs given processing based on a result of the detection.

6. A terminal device according to claim 5, wherein the control part determines an operation mode of a user for the elastic body based on the detection result of the variation over time in the amount of deflection, and outputs a result of the determination.

7. A terminal device according to claim 5, wherein the terminal device includes an accommodating portion which accommodates the elastic body of the operation input device in a casing of the terminal device.

8. A terminal device according to claim 5, wherein a grip portion which allows the gripping of casing of the terminal device is mounted on a side of the elastic body of the operation input device.

9. A terminal device according to claim 5, wherein the operation input device is provided on both sides of a casing of the terminal device respectively.

10. A terminal device comprising:
(a) an operation input part which includes an elastic body that is resilient, a device which detects an amount of deflection of the elastic body in accordance with an operation of a user, and a device which outputs information relating to the detected amount of deflection; and
(b) a control part which performs processing to display a document constituted of a plurality of pages, and changes a page turning speed of the document in response to the amount of deflection of the elastic body of the operation input device.

11. A computer readable recording medium storing a program which is executed by a computer to which an operation input device which includes an elastic body that is resilient, a device which detects an amount of deflection of the elastic body attributed to an operation of a user, and a device which outputs information relating to the detected amount of deflection is connected, wherein
the program executes the steps of:
receiving inputting of information relating to the amount of deflection of the elastic body from the operation input device:
displaying a document constituted of a plurality of pages; and
changing a page turning speed of the document in response to the received information.
